(19) United States
(12) Patent Application Publication
(10) Pub. No.: US 2006/0210040 A1
(43) Pub. Date: Sep. 21, 2006

(54) Transfer identification software enabling electronic communication system

(76) Inventors: Jeffrey Citron, Edison, NJ (US); Andrew Wason, Atlantic Highlands, NJ (US); Nilesh Shah, Monmouth, NJ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/081,186

(22) Filed: Mar. 16, 2005

(51) Int. Cl. H04M 3/00

(52) U.S. Cl. 379/189

(57) ABSTRACT

A third party call control (3PCC) application program interface (API) provides the capability for users to use a web browser or other Internet capable software to place a call. A third party call control application program interface comprises a first uniform resource locator operable over the Internet to effect a call between a first telephonic device and a second telephonic device. The first uniform resource locator includes identification of the first telephonic device and identification of the second telephonic device.

### BACKGROUND OF THE INVENTION

1. Field of the Invention

The present invention relates to a third party call control (3PCC) application program interface (API). The present invention also relates to novel uses of a web browser or other Internet capable software. Specifically, the present invention relates to transfer identification software that enables telephonic call completion. In one specific aspect, the present invention specifically relates to a virtual card for telephonic call completion.

2. Description of the Related Art

Voice over Internet Protocol (VoIP) is a category of hardware and software that enables people to use the Internet as the transmission medium for telephone calls by sending voice data in packets using Internet Protocol (IP) rather than by traditional circuit transmissions of the Public Switch Telephone Network (PSTN). This allows the elimination of circuit switching and the associated waste of bandwidth. Instead, packet switching is used, where IP packets with voice data are sent over the network only when data needs to be sent, i.e. when a caller is talking.

The advantages of VoIP over traditional telephony include, by way of example, the following:

lower costs per call, especially for long-distance calls, and

lower infrastructure costs.

Once the IP infrastructure is installed, no or little additional telephony infrastructure is required.

However, despite the technological flexibility of VoIP system, callers are still limited to initiating calls manually, using the keypad on a telephone. A need arises for users to initiate calls using other techniques.

### SUMMARY OF THE INVENTION

The third party call control (3PCC) application program interface (API) of the present invention provides the capability for users to use a web browser or other Internet capable software to place a call, rather than using an alphanumeric keypad on a telephonic device, such as telephone. The open nature of the API also provides the capability to integrate 3PCC functionality with new or existing applications like customer relationship management (CRM), Contact management applications, and the like.

In one embodiment of the present invention, a third party call control application program interface comprises a first uniform resource locator operable over the Internet to effect a call between a first or predetermined telephonic device and a second telephonic device. The first uniform resource locator includes identification of the first telephonic device and identification of the second telephone device.

In one aspect of the present invention, the first uniform resource locator may be generated on a computer system that is communicatively connected to the Internet. The call may be completed by initiating a call to the first telephonic device and then transferring the call, to complete the call, to the second telephonic device, at the time the call to the first telephonic device is answered. The call may be initiated to the first telephonic device using the Session Initiation Protocol INVITE method. The call may be transferred to the second telephonic device using the Session Initiation Protocol REFER method.

In one aspect of the present invention, the identification of the first telephonic device may include a telephone number of the first telephonic device and the identification of the second telephonic device may include a telephone number of the second telephonic device. The third party call control application program may further include identification of an account to be billed. The identification of the account to be billed may include the telephone number of the first telephonic device, the telephone number of the second telephonic device, or the telephone number of a third telephonic device.

In one aspect of the present invention, the third party call control application program may further include a second uniform resource locator operable over the Internet to obtain information identifying an account to be billed. The information identifying an account to be billed may include at least one telephone number. At least one of the first uniform resource locator identification of the first telephonic device and the first uniform resource locator identification of the second telephonic device may include the at least one telephone number obtained by the second uniform resource locator.

In one aspect of the present invention, the third party call control application program may further include identification and password information which information is authenticated and validated before completion of the call.

### BRIEF DESCRIPTION OF THE DRAWINGS

FIG. 1 is an exemplary block diagram of a system in which the present invention may be implemented.

FIG. 2 is an exemplary diagram of an implementation of a contact list interface to functionality of the present invention.

FIG. 3 illustrates an example of a vcard, implementing functionality of the present invention.

### DETAILED DESCRIPTION OF THE INVENTION

The third party call control (3PCC) application program interface (API) of the present invention provides the capability for users to use a web browser or other Internet capable software to place a call, rather than using a keypad on a telephone. The open nature of the API also provides the capability to integrate 3PCC functionality with new or existing applications like customer relationship management (CRM), Contact management applications, etc.

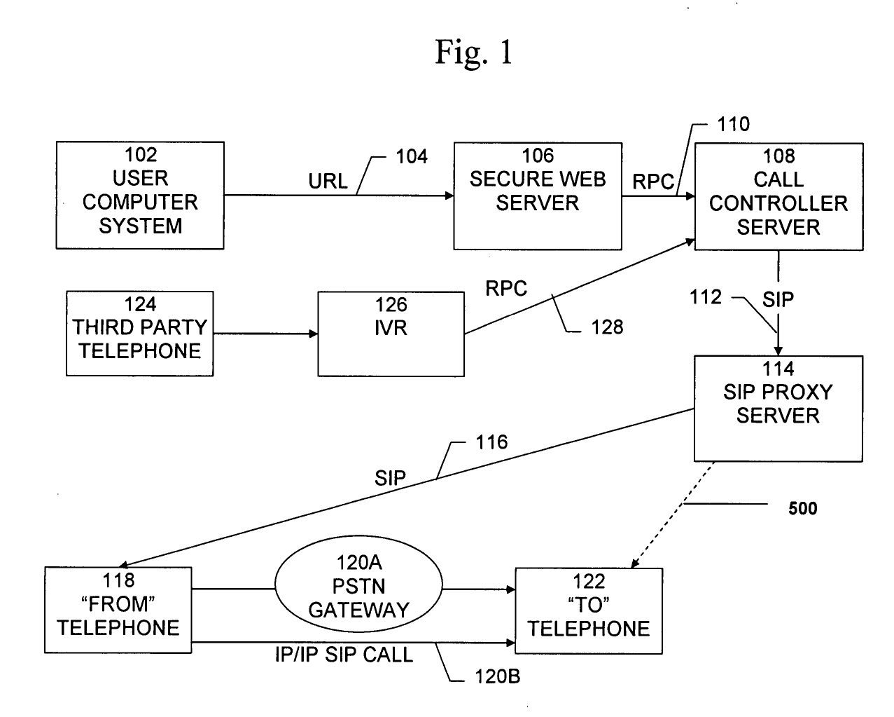

A system in which the present invention may be implemented is shown in FIG. 1. In one embodiment, a user computer system 102, is used to access the Internet and invoke the 3PCC API using a secure hyper-text transfer protocol (HTTPS) uniform resource locator (URL) 104 (secure sockets layer (SSL)). The URL is used to pass authorization credentials, such as login information, along with at least two phone numbers, a “from” number and a “to” number. An example of a suitable URL is:
https://secure.url.com/tpcc/makecall?username=aw&password=secret &
fromnumber=1732555111&tonumber=17325552222

This URL includes specification of the secure hyper-text transfer protocol (https:), the Internet address of web server 106 (secure.url.com), the action to be performed by web server 106 (makecall), the authorization credentials (username=aw&password=secret), the telephone number of the telephone from which the call is to originate (fromnumber=17325551111) and the telephone number of the telephone to which the call is to be completed (tonumber=17325552222).

The HTTP URL activates secure web server 106, which authenticates the user and passes the information to a CallController system 108. Preferably, the information is passed from secure web server 106 to CallController 108 using a Remote Procedure Call (RPC) 110. The CallController 108 is a trusted peer of Session Initiation Protocol (SIP) proxy server 114.

SIP is a signaling protocol for Internet conferencing, telephony, presence, events notification and instant messaging. SIP provides the necessary protocol mechanisms so that end systems and proxy servers can provide services such as call completion, call forwarding, callee and calling “number” delivery, personal mobility, terminal-type negotiation and selection, terminal capability negotiation, caller and callee authentication, blind and supervised call transfer, invitations to multicast conferences.

A goal for SIP was to provide a superset of the call processing functions and features present in the public switched telephone network (PSTN). As such, features that permit familiar telephone-like operations are present: dialing a number, causing a phone to ring, hearing ringback tones or a busy signal. Implementation and terminology are different; for example, SIP refers to a device being in an “alerting state” rather than “ringing.”

In response to receiving the RPC 110 from secure web server 106, CallController 108 invokes a number of SIP methods 112 involving SIP proxy server 114. In response, SIP proxy server 114 invokes those SIP methods 116 to the appropriate target. In addition, SIP proxy server 114 monitors any calls that are initiated and completed, in order to handle the necessary billing functions.

In particular, CallController 108 initiates a call from CallController 108 to the “from” number, using the SIP INVITE method. SIP proxy server 114 in turn invokes the SIP INVITE method 116 targeting the “from” telephone 118. The technique used to invoke the SIP INVITE method depends upon the type of “from” telephone 118 involved. For example, if the “from” telephone 118 is an Internet Protocol (IP) telephone, the SIP INVITE method 120B may be invoked directly on the “from” telephone 118, since the IP telephone is capable of performing the necessary functions in response to the invocation of the SIP INVITE method. Alternatively, if the “from” telephone 118 is a standard Public Switched Telephone Network (PSTN) telephone, then the SIP INVITE method is invoked using a PSTN gateway server 120A to initiate the call. In either case, a call to the “from” telephone 118 is initiated.

When the “from” telephone 118 answers, CallController 108 initiates a call transfer to transfer the call to the “from” telephone 118 from the origin of the call, CallController 108, to the “to” telephone 122 number, using the SIP REFER method. This terminates the initial call between the CallController and the “from” telephone 118, and triggers the “from” telephone 118 to initiate a new call to the “to” telephone 122. This call is billed to the appropriate account.

There are three possible numbers to which the call may be billed—the “from” number, the “to” number, or a third “billto” number. The number to which the call is billed must belong to a subscriber of the telephone service provider. Thus, if the “from” number belongs to the subscriber, the call is billed to the “from” number, if the “to” number belongs to the subscriber, the call is billed to the “to” number, if neither the “from” number nor the “to” number belong to the subscriber, a third number must be billed. This third number may be supplied in the URL 104 or it may be associated with the user name that was used to login. An example of a suitable URL including a “billto” number is:
https://secure.url.com/tpcc/makecall?username=aw&password=secret &
fromnumber=1732555111 &tonumber=17325552222&
billtonumber=17325553333

Preferably, an additional HTTPS URL is exposed which allows an application to retrieve a list of phone numbers in a user's account. This URL is passed authorization credentials (login information) and returns the phone numbers associated with the account corresponding to that login information. This list can be presented to the user to select which number is to initiate the call (the “from” number), and/or to select which number is to be billed for the call (the “billto” number).

Although, typically, user computer system 102 is used to initiate the telephone calls, calls may also be initiated from a third party telephone 124. Third party telephone 124 would dial into an interactive voice response (IVR) system 126 and would be used to enter the information needed to initiate the telephone call. IVR 126 would pass the information to CallController 108 using RPC 128. The system would then initiate the call in a manner similar to that for a call initiated from user computer system 102.

The third party telephone configuration slightly changes the role of “from” telephone 118, as compared to the configuration involving only the “to” and “from” telephones. Both “to” telephone 122 and “from” telephone 118 become the “to” telephones. If the third party places a call to “from” telephone 118, SIP proxy server 114 invokes SIP INVITE methods 116, as discussed above. However, if third party telephone 124 is trying to reach “to” telephone 122, the inventive system may have an alternative and additional communication link 500 adaptively operable in response to invoking methods similar to SIP INVITE methods 116 by SIP Proxy Server 114.

As a further possibility, CALL CONTROLLER SERVER 108 can always directly call “to” telephone 122 using the link similar to communication link 500. One of possible scenarios involving such a direct connection may involve a situation when the caller operating the “from” telephone does not want experience any delays due to the busy line. Instructing the controller server to initiate contact with the “to” telephone and, once the operator of the “to” telephone answers the call from the controller server, actually connecting the “from” and “to” telephones may save the operator of the “from” telephone time.

The configuration of the inventive system involving third party telephone 124 may have numerous practical ramifications and be used in a variety of ways. For instance, one potential use of this is similar to a “calling card”. The subscriber could initiate a call from any telephone, such as their hotel room telephone or a pay telephone, to any other phone, while billing the call to their own account.

Examples of users of the services provided by the present invention include business users who have a large phone book of users they need to call (e.g. sales calls), or by telemarketing operations. In this situation, the subscriber uses the “from” telephone and the calls are billed to the “from” number.

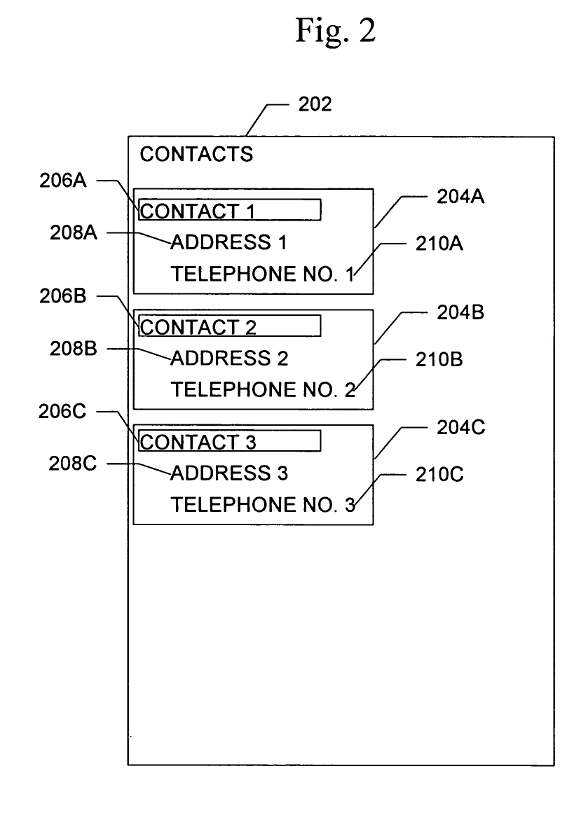

For example, this could be implemented in phone or address book software, such as using a plugin to an email program such as MICROSOFT OUTLOOK@, or in contact manager software. An example of such an implementation is shown in FIG. 2. In this example, a contacts window 202 includes a plurality of contacts entries 204A-C. Each contact entry 204A-C includes a contact address 208A-C and a contact telephone number 210A-C. Associated with each contact telephone number 210A-C is a software control, which, when activated causes the telephone number 210A-C to be dialed using the third party call control system shown in FIG. 1. The software control may take any form. For example, the software control may be a button or an active area associated with the telephone number 210A-C. Alternatively, the software control may be a hotkey, which may operate, for example, by a user selecting a telephone number and then pressing the hotkey. These are merely examples of suitable software controls; any software control with adequate functionality may be used.

In order to dial the telephone number 210A-C using the third party call control system shown in FIG. 1, a URL, such as those shown above, is used. The telephone number 210A-C is included in the URL, typically as the “to” number. The “from” number would typically be the phone number of a phone available to the person initiating the call. The “billto” number may be omitted from the URL, in which case the “from” number would typically be billed, or a third “billto” number may be included in the URL.

Additional enhancement to this functionality include the capability to scan pages and documents for character strings that appear to be telephone numbers. These telephone numbers may be highlighted for the user. The user may then dial any such telephone number by selecting the number and pressing the hotkey or other software control.

Preferably, the implementation includes sufficient intelligence to understand the formats of telephone numbers, including international telephone numbers, as well as the ability to filter the characters in the telephone number to strip characters such as parentheses, hyphens, etc.

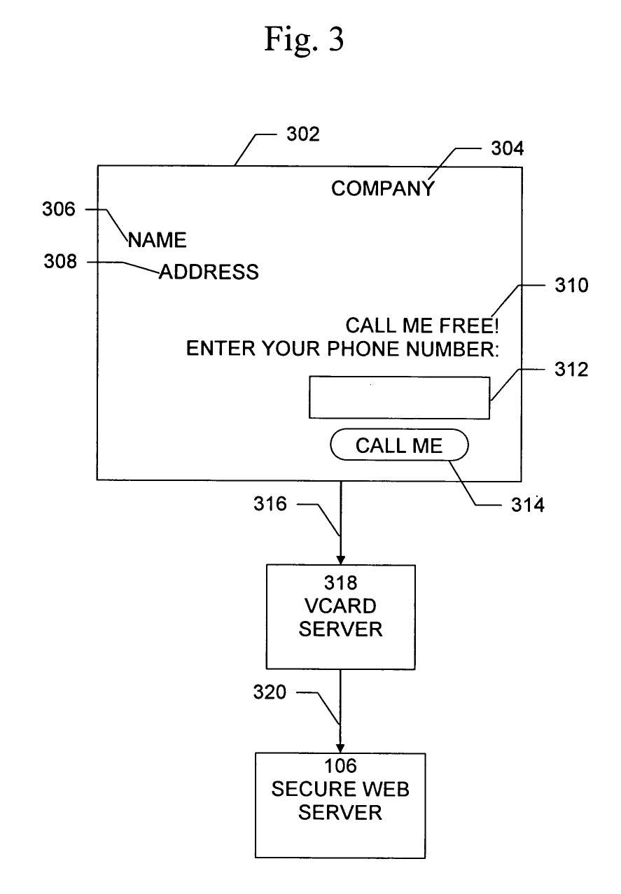

In another embodiment, subscribers could distribute software objects that provide the capability for the recipient of the object to call the subscriber. Typically, the software object is distributed using email, but it may be distributed by download or any form of electronic communications. An example of such a software object is shown in FIG. 3. In the example shown in FIG. 3, the software object is a virtual contact card or “vcard” 302. In this example, vcard 302 includes information such as a company name 304, the subscriber's name 306, the address 308, and instructions for initiating a call 310. In addition vcard 302 includes a field in which the recipient of the vcard is to enter their telephone number 312 and a software control 314, such as a button, that initiates the telephone call. The information provided, the company name 304, the subscriber's name 306, the address 308, and instructions for initiating a call 310, are merely examples and any desired information may be included in the vcard. Likewise, field 312 and software control 314 are merely examples of a software mechanism that may be used for operation of the vcard.

Included in or associated with vcard 302 and/or software control 314 is software that initiates a telephone call between the subscriber and the recipient of the vcard. When the recipient enters a telephone number in field 312 and activates software control 314, vcard 302 generates a URL and uses the URL to transmit information 316 to a vcard server 318. While the transmitted information 316 may include the identification and password information of the subscriber, preferably, transmitted information 316 does not include this information in an insecure form. For example, transmitted information 316 may include the identification and password information of the subscriber in an encrypted form, or transmitted information 316 may be a token that is used by vcard server 318 to obtain the identification and password information of the subscriber, such as by a database lookup.

Vcard server 318 receives the transmitted information 316 and generates a URL that is used to transmit information 320 to secure web server 106. This URL is similar to that generated by user computer system 102, shown in FIG. 1, which is used to communicate with secure web server 106. If the transmitted information 316 is encrypted identification and password information of the subscriber, vcard server 318 decrypts the information and uses it to generate the URL. If the transmitted information 316 is a token, vcard server 318 validates the token, then uses the token to obtain the identification and password information of the subscriber, such as by using the token to access a database that contains the identification and password information of the subscriber. In any case, the URL is used to transmit information 320 to secure web server 106, which initiated the telephone call in a manner similar to that shown in FIG. 1.

Typically, vcard 302 includes information such as the network address of vcard server 318, token and/or encryption information, and information identifying the sender of the vcard. Alternatively, vcard 302 could include a unique token that identifies the particular call setup to be initiated, but which does not itself include information that identifies the subscriber account involved. Of course, various modifications are possible, such as including the identification information, but not the password, and the like.

In the example shown in FIG. 3, vcard 302 included field 312 in which the recipient of the vcard entered the telephone number to which the telephone call was to be completed. Alternatively, the sender of the vcard or other software object could specify a particular number to which the telephone call is to be completed. This would allow a subscriber to control the particular calls that can be made. For example, the subscriber could generate one software object that initiated a call from their grandmother's phone to the subscriber's phone, another software object that initiated a call from a friend's phone to the subscriber's phone, etc. This allows parties to initiate calls to the subscriber from their phone at any time, while billing the subscriber, the “to” number.

In addition, the sender of software object may be allowed to specify conditions for use of the software object. For example, the sender may specify that the software object expires after a particular date, the sender may specify time of day restrictions on the calls, the sender may restrict international calls, etc. If the transmitted information is encrypted, this information may be included in the encrypted information. If the transmitted information is a token, the database may include the appropriate conditional information.

Although specific embodiments of the present invention have been described, it will be understood by those of skill in the art that there are other embodiments that are equivalent to the described embodiments. For example, the present invention may also be advantageously applied to three-way and/or multiple party conferencing. For three-way conferencing, the system shown in FIG. 1 would be used to initiate two calls to the same telephone. Typically, the first call would be completed to the telephone, the second call would be initiated, the telephone would receive a call waiting indication, and the second call would be conferenced in to the first. For multiple party conferencing, the system shown in FIG. 1 would be used to initiate multiple calls to a conference bridge, with all calls billed to the account of the conference organizer.

In addition, it is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Accordingly, it is to be understood that the invention is not to be limited by the specific illustrated embodiments, but by the scope of the appended claims.

What is claimed is:

1. A telephonic control method for effecting a telephone call comprising:
(a) receiving a software object comprising a software control operable to initiate a telephone call to a predetermined telephonic device;
(b) operating the software control to initiate the telephone call; and
(c) generating, with the software control, a uniform resource locator operable over a computer network to effect a call between the predetermined telephonic device and a second telephonic device.

2. The method of claim 1, wherein the uniform resource locator comprises means for identifying the predetermined telephonic device and identification of the second telephonic device.

3. The method of claim 2, wherein the identification of the predetermined telephonic device comprises a telephone number.

4. The method of claim 3, wherein the identification of the second telephonic device comprises a telephone number.

5. The method of claim 4, wherein the telephone number of the second telephonic device is entered by a receiver of the software object.

6. The method of claim 4, wherein the telephone number of the second telephonic device is defined in the software object.

7. The method of claim 1, wherein the uniform resource locator comprises a token operable to obtain identification of the predetermined telephonic device and identification of the second telephonic device.

8. The method of claim 7, wherein the token comprises a telephone number of the predetermined telephonic device.

9. The method of claim 7, wherein the token is operable to obtain identification and password information, said information being authenticated and validated before completion of the telephone call.

10. The method of claim 9, wherein the identification and password information is obtained from a database.

11. The method of claim 7, wherein the token comprises expiration information.

12. The method of claim 11, wherein the expiration information comprises at least one selected from expiration date and time of day, and wherein a restriction information on the second telephonic device is stored in a database.

13. A method of telephonic call completion comprising:
(a) receiving information indicating a call to be completed between a first telephonic device and a second telephonic device, said information comprising an account to which the call is to be billed, and wherein the information is generated by a software object;
(b) validating the account to which the call is to be billed; and
(c) completing the call between the first telephonic device and the second telephonic device.

14. The method of claim 13, wherein the received information comprises a token.

15. The method of claim 14, wherein the step (b) of validating the account to which the call is to be billed comprises:
(i) obtaining identification information and password information using the token; and
(ii) validating and authenticating the identification information and the password information.

16. The method of claim 15, wherein the identification and password information are obtained from a database using the token.

17. The method of claim 15, wherein the identification information comprises a telephonic number.

18. A software object for telephonic call completion comprising:
a software control comprising means for generating a uniform resource locator operable over a computer network to effect a call between a first telephonic device and a second telephonic device.

19. The software object of claim 18, wherein the uniform resource locator comprises identification of the first telephonic device and identification of the second telephonic device.

20. The software object of claim 19, wherein the identification of the at least one of the first and second telephonic devices is a telephone number.

21. The software object of claim 19, wherein the identification of the second telephonic device is a telephone number.

22. The software object of claim 21, wherein the telephone number of the second telephonic device is entered by a receiver of the software object.

23. The software object of claim 21, wherein the telephone number of the second telephonic device is predefined.

24. The software object of claim 18, wherein the uniform resource locator comprises a token, said token operable to obtain identification of the first telephonic device and identification of the second telephonic device.

25. The software object of claim 24, wherein the token comprises the telephone number of at least one of the first and second telephonic devices.

26. The software object of claim 24, wherein the token comprises means for obtaining identification information and password information, and means for authenticating and validating the identification information and password information before completion of the call.

27. The software object of claim 26, wherein the identification information and password information is obtained from a database.

28. The software object of claim 24, wherein the token comprises expiration information, includes time of day restrictions, or includes restrictions on the second telephonic device.

29. The software object of claim 28, wherein the expiration information comprising date and the time of day information, and wherein the expiration information for the second telephonic device is stored in a database.
